(19) United States
(12) Patent Application Publication
(10) Pub. No.: US 2012/0249578 A1
(43) Pub. Date: Oct. 4, 2012

(54) DISPLAY UNIT, DISPLAY METHOD AND RECORDING MEDIUM

(75) Inventors: Takeshi TANI, Osaka (JP); Masanori MATSUMOTO, Osaka (JP)

(73) Assignee: SHARP KABUSHIKI KAISHA, Osaka (JP)

(21) Appl. No.: 13/433,347

(22) Filed: Mar. 29, 2012

(30) Foreign Application Priority Data
Apr. 1, 2011 (JP) 2011-082206

(51) Int. Cl. G09G 5/00

(52) U.S. Cl. 345/619

(57) ABSTRACT

A display unit, including a display part displaying content in a display screen, a detection part detecting an operation performed on the display screen of the display part, and an information display part displaying, on the basis of a detection result obtained by the detection part, damage information corresponding to simulated damage formed in the content due to the operation.

### CROSS-REFERENCE TO RELATED APPLICATION

This Nonprovisional application claims priority under 35 U.S.C. §119(a) on Patent Application No. 2011-82206 filed in Japan on Apr. 1, 2011, the entire contents of which are hereby incorporated by reference.

### FIELD

The present invention relates to a display unit, a display method and a recording medium used for displaying desired content as well as displaying information on simulated damage formed in the content.

### BACKGROND

Various portable information terminals capable of reproducing digital contents have spread in recent years. Among such terminals, portable information terminals in which so-called digital books may be installed for enjoying reading at any time in any place have been widely spread.

For example, Japanese Patent Application Laid-Open No. 2000-163193 discloses portable information equipment in which a touch panel is disposed in a display screen so that page images may be successively turned by touching, with a finger, an image of a page displayed in the display screen and sliding it in a turning direction in the same manner as in turning a page of a real book or so that display may directly jump to a specific page by touching a desired tab.

Furthermore, Japanese Patent Application Laid-Open No. 2003-163742 discloses a portable terminal device that includes an acceleration sensor for detecting acceleration such as vibration applied to the device and measures a time period of the application of the acceleration for accepting a prescribed instruction.

Moreover, Japanese Patent Application Laid-Open No. 2010-252201 discloses a portable terminal that has a communication function such as a telephone function and a mailing function, includes a direction sensor for detecting a direction of the portable terminal or an acceleration sensor, accepts a prescribed instruction in accordance with the direction of the portable terminal and the speed of change in the direction, and conducts voice guidance of the details on the accepted instruction.

In the conventional portable information terminals described above, however, damage such as rumples, tears and soils caused by use are not expressed as in a real book, no matter how they are operated, and hence, they are not perfect from the viewpoint of reproduction of a real book. Since displayed content is not changed in its newness even through use for a long period of time, it may make a user who is familiar with real books feel uncomfortable.

In use of a real book, for example, as the number of times of reading and the time duration of the reading are increased, the book becomes old, paper may be torn when a page is turned with force, or the book becomes easy to be opened to prescribed facing pages when a binding part between the facing pages is pressed many times. Thus, there remains a certain extent of damage in the book. Such damage caused in use by a user (a reader) is, however, not considered at all in the inventions described in any of Japanese Patent Application Laid-Open Nos. 2000-163193, 2003-163742 and 2010-252201.

### SUMMARY

The present invention was devised in consideration of the aforementioned circumstances, and an object of the invention is providing a display unit, a display method and a recording medium that do not make a user who is familiar with real books feel uncomfortable as follows. When content is displayed in a display screen, simulated damage such as a tear or an easily opened page caused in the content is displayed in the display screen, so as to attain an effect to make the content similar to a real book, and every time the content is displayed, the simulated damage previously formed is also displayed correspondingly to the content, so as to make the content further closer to a real book.

The display unit of this invention includes: a display part displaying content in a display screen; a detection part detecting an operation performed on the display screen of the display part; and information display part displaying, on the basis of a detection result obtained by the detection part, damage information corresponding to simulated damage formed in the content due to the operation.

According to this invention, the operation performed on the display screen of the display part is detected by the detection part, and on the basis of the detection result obtained by the detection part, the information display part displays damage information corresponding to simulated damage formed in the content due to the operation.

The display unit of this invention further includes a determination part determining the damage information on the basis of details of the operation and/or the number of times the operation is performed.

According to this invention, the damage information may be determined by the determination part on the basis of the details of the operation and/or the number of times the operation is performed.

In the display unit of this invention, the content may be an image group including images of a plurality of pages.

According to this invention, the content includes images of a plurality of pages, and when a specific page is displayed, damage information corresponding to the specific page is displayed by the information display part.

The display unit of this invention may further include a storage part storing the damage information in correspondence with a page of the content where the simulated damage corresponding to the damage information has been formed, and when the page is displayed in the display part, the information display part displays damage information corresponding to the page.

According to this invention, damage information is stored in the storage part in correspondence with a page of content where simulated damage is formed, and when the page is displayed, the information display part displays the damage information corresponding to the page.

In the display unit of this invention, when the operation is detected as a touch operation performed on the display screen, the detection part detects a contact area in the display screen of the touch operation.

According to this invention, when the operation is detected by the detection part as a touch operation performed in the display screen, a contact area in the display screen of the touch operation is detected, and appropriate damage information based on the detected contact area is displayed by the information display part.

In the display unit of this invention, when the operation is detected as a touch operation on the display screen accompanying movement, the detection part detects a moving speed of the touch operation on the display screen.

According to this invention, when the operation is detected as a touch operation performed on the display screen by the detection part, a moving speed of the touch operation on the display screen is detected, and appropriate damage information based on the detected moving speed is displayed by the information display part.

The display unit of this invention further includes means for detecting movement thereof.

According to this invention, the display unit includes the means for detecting movement thereof, and appropriate damage information based on the detected movement of the display unit is displayed by the information display part.

The display unit of this invention further includes means for detecting attitude thereof, and the information display part clears damage information displayed by the information display part on the basis of the detected movement and attitude.

According to this invention, the display unit includes means for detecting attitude thereof, and on the basis of the detected movement and attitude of the display unit, damage information displayed by the information display part may be cleared.

The display method of this invention, which is employed in a display unit for displaying content in a display screen, includes: detecting an operation performed on the display screen of the display unit; and displaying, on the basis of a detection result, damage information corresponding to simulated damage formed in the content due to the operation.

According to this invention, an operation performed in the display screen of the display unit is detected, and on the basis of the detection result, damage information corresponding to simulated damage formed in the content due to the operation is displayed.

The computer program of this invention, which is employed in a computer included in a display unit equipped with a display part displaying content in a display screen and a detection part detecting an operation performed on the display screen of the display part, includes the steps of: allowing the computer to determine whether or not the operation detected by the detection part is a prescribed operation; and allowing the computer to determine damage information corresponding to simulated damage formed in the content due to the operation when the detected operation is determined as the prescribed operation.

According to this invention, an operation performed on the display screen of the display part is detected, and on the basis of the detection result obtained by the detection part, it is determined whether or not the detected operation is a prescribed operation, and when the detected operation is determined as a prescribed operation, damage information corresponding to simulated damage formed in the content due to the operation is determined.

The recording medium of this invention stores the computer program of this invention.

According to this invention, the computer program is stored in the recording medium. The computer reads the computer program from the recording medium, so as to realize the aforementioned display unit and display method by the computer.

According to the present invention, when content is displayed in the display screen, simulated damage such as a tear or an easily opened page caused in the content is displayed in the display screen on the basis of an operation performed by a user on the display screen, so as to attain an effect to make the content similar to a real book, and every time the content is displayed, the simulated damage previously formed is also displayed correspondingly to the content, so as to make the content further closer to a real book and so as not to make a user who is familiar with real books feel uncomfortable.

The above and further objects and features of the invention will more fully be apparent from the following detailed description with accompanying drawings.

### BRIEF DESCRIPTION OF DRAWINGS

FIG. 1 is a functional block diagram illustrating a main part configuration of a book data display unit according to Embodiment 1 of the invention;

FIG. 2 is a diagram conceptually illustrating an information management table of the book data display unit according to Embodiment 1 of the invention;

FIG. 3 is a flowchart used for explaining display processing performed in the book data display unit according to Embodiment 1 of the invention;

FIG. 4 is a flowchart illustrating a specific example of processing performed when a prescribed operation is accepted;

FIG. 5 is a schematic diagram illustrating a page turning operation performed by a user;

FIG. 6 is a flowchart illustrating an example of processing for determining damage information derived from the page turning operation;

FIG. 7 is a schematic diagram simulatively displaying, in a display screen, damage caused by the page turning operation;

FIG. 8 is a schematic diagram illustrating a binding part pressing operation performed by a user;

FIG. 9 is a flowchart illustrating an example of the processing for determining damage information derived from the binding part pressing operation;

FIG. 10 is a schematic diagram simulatively displaying, in a display screen, damage caused by the binding part pressing operation;

FIG. 11 is a schematic diagram illustrating an example of a display form of damage information;

FIG. 12 is a functional block diagram illustrating a main part configuration of a book data display unit according to Embodiment 2 of the invention;

FIG. 13 is a functional block diagram illustrating a main part configuration of a detection part of the book data display unit according to Embodiment 2 of the invention; and

FIG. 14 is a functional block diagram illustrating a main part configuration of a book data display unit according to Embodiment 3 of the invention.

### DESCRIPTION OF EMBODIMENTS

Now, a display unit, a display method and a computer program according to embodiments of the invention will be described with reference to the accompanying drawings by exemplifying its application to a book data display unit.

### Embodiment 1

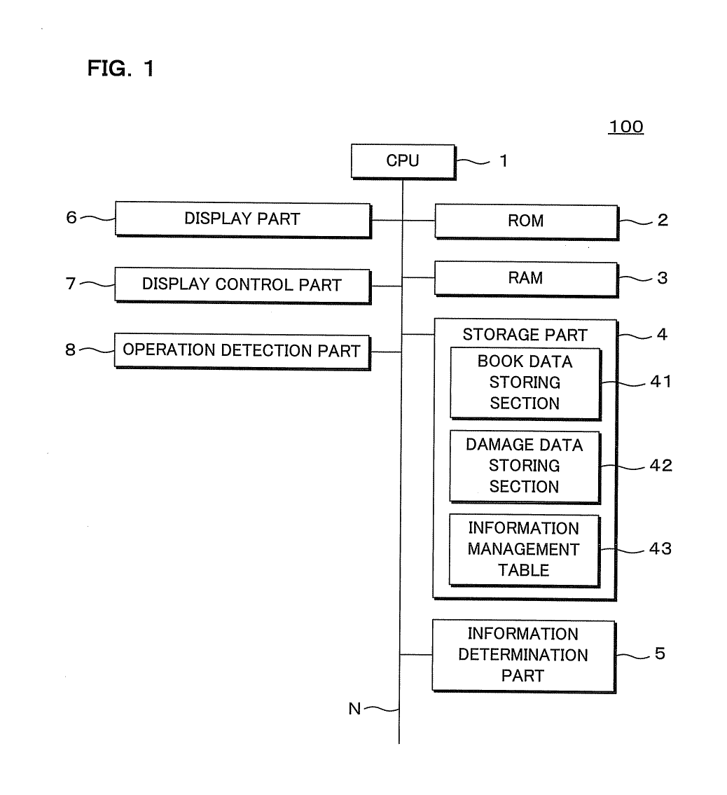

FIG. 1 is a functional block diagram illustrating a main part configuration of a book data display unit 100 according to Embodiment 1 of the invention. The book data display unit 100 includes a CPU 1, a ROM 2 and a RAM 3.

The ROM 2 previously stores various control programs and basically fixed data and the like out of parameters used for calculation, and the RAM 3 is capable of temporarily storing data and reading the stored data regardless of storing orders, stored positions and the like. Furthermore, the RAM 3 stores, for example, a program read from the ROM 2, various data generated by executing the read program and parameters and the like appropriately changing in the execution.

The CPU 1 controls various hardware described later through a bus N by loading a control program previously stored in the ROM 2 onto the RAM 3 and by executing the control program, so as to make the entire unit operate as the book data display unit 100 of the invention. Furthermore, the CPU 1 accepts input of a processing instruction from a user through an operation detection part 8 described later.

The book data display unit 100 of Embodiment 1 of the invention further includes a storage part 4, an information determination part 5, a display part 6, a display control part 7 and the operation detection part 8.

The storage part 4 is constructed of a nonvolatile recording medium such as a flash memory, an EEPROM, an HDD, an MRAM (a magneto-resistive random access memory), an FeRAM (a ferroelectric random access memory) or an OUM. Furthermore, the storage part 4 includes a book data storing section 41, a damage data storing section 42 and an information management table 43.

The book data storing section 41 stores data on a plurality of books. Each book data is content data of a digital book including images of a plurality of pages, and the display control part 7 displays, on the basis of the book data, a page image of the digital book in the display part 6. Furthermore, the book data is downloaded from an external communication network through an I/F not shown or is read from a portable recording medium not shown, so as to be stored in the book data storing section 41 as described above.

The damage data storing section 42 stores image data corresponding to simulated damage caused by every operation (hereinafter referred to as damage data). Examples of the simulated damage are a “rumple”, a “tear” and a “corner soil” caused by a page turning/returning operation, a “dog-ear” caused by an operation to fold a corner of a page, and various extents of “width increase of a binding part” caused by an operation to press the binding part.

The information management table 43 lists details of the book data stored in the book data storing section 41 and damage data of each book data and is used for managing damage data of each book data stored in the book data storing section 41 of the storage part 4. The damage data is displayed in the book data display unit 100 on the basis of the information management table 43.

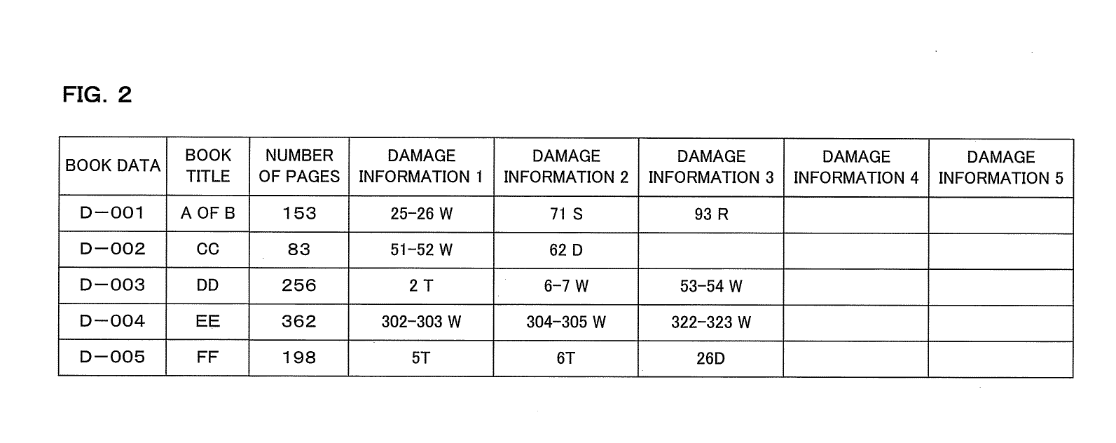

FIG. 2 is a diagram conceptually illustrating the information management table 43 of the book data display unit 100 of Embodiment 1. As illustrated in FIG. 2, in the information management table 43, the number of a digital book, the title of the book and the number of pages of the book are listed as the details of the book data, and damage information of simulated damage is listed in correspondence with a page (number) where the simulated damage is formed. In FIG. 2, the aforementioned “rumple”, “tear”, “corner soil”, “dog-ear” and “width increase of a binding part” described above are simply expressed respectively as “R”, “T”, “5”, “D” and “W” for convenience of explanation.

Specifically, the information management table 43 lists the following: with respect to book data D-001, the title of the book is “A of B”, and the number of pages is 153; as damage information 1, a binding part between page 25 and page 26 is to be displayed to have a large width; as damage information 2, a soil is to be displayed on a corner of page 71; and as damage information 3, a rumple is to be displayed on page 93. Furthermore, with respect to book data D-002, the title of the book is “CC” and the number of pages is 83; as damage information 1, a binding part between page 51 and page 52 is to be displayed to have a large width; and as damage information 2, a dog-ear is to be displayed on page 62. With respect to book data D-003, the title of the book is “DD” and the number of pages is 256; as damage information 1, a tear is to be displayed on page 2; as damage information 2, a binding part between page 6 and page 7 is to be displayed to have a large width; and as damage information 3, a binding part between page 53 and page 54 is to be displayed to have a large width. With respect to book data D-004, the title of the book is “EE” and the number of pages is 362; as damage information 1, a binding part between page 302 and page 303 is to be displayed to have a large width; as damage information 2, a binding part between page 304 and page 305 is to be displayed to have a large width; and damage information 3, a binding part between page 322 and page 323 is to be displayed to have a large width. With respect to book data D-005, the title of the book is “FF” and the number of pages is 198; as damage information 1, a tear is to be displayed on page 5; as damage information 2, a tear is to be displayed on page 6; and as damage information 3, a dog-ear is to be displayed on page 26.

The information determination part 5 determines damage information corresponding to simulated damage to be displayed in accordance with an instruction issued by the CPU 1. Specifically, the information determination part 5 determines the form and the extent of damage corresponding to an operation on the basis of a detection result obtained by the operation detection part 8 described later.

The display part 6 is constructed from an LCD, an EL (electroluminescence) panel or the like, and displays contents of digital books. Furthermore, a display screen of the display part 6 is covered with a touch panel of the operation detection part 8 described later.

The display control part 7 includes a processor such as a DSP (digital signal processor) and controls image display in the display part 6. For example, it generates image data of an image to be displayed in the display part 6 in accordance with an instruction issued by the CPU 1. Specifically, the display control part 7 generates image data of content of a digital book to be displayed in the display part 6 on the basis of the book data so as to display an image based on the created image data (i.e., the content of the digital book) in the display part 6, or generates image data of simulated damage to be displayed in the display part 6 on the basis of the damage information so as to display an image based on the generated image data in the display part 6.

The operation detection part 8 includes the so-called touch panel provided so as to cover the display screen of the display part 6. The operation detection part 8 accepts position specification on the display screen of the display part 6 through, for example, a touch operation performed by a user on the touch panel, and detects the details of an instruction given by the user through the touch operation.

The operation detection part 8 detects coordinates on the display screen of the display part 6 corresponding to a contact point of a fingertip of a user by detecting, for example, change in pressure caused by the touch operation performed with the fingertip of the user or by detecting an electric signal electrostatically generated, and generates a signal for specifying the coordinates. Furthermore, the operation detection part 8 detects any of operations such as operations to turn a page, return a page, dog-ear and press a binding part on the basis of, for example, change in the detected coordinates, or detects a moving speed and a contact area of the fingertip of the user in the display screen. It is noted that the operation detection part 8 is not limited to such a structure but may include a pointing device (such as a stylus pen) or the like.

Display processing conducted in the book data display unit 100 of Embodiment 1 of the invention will now be described in detail.

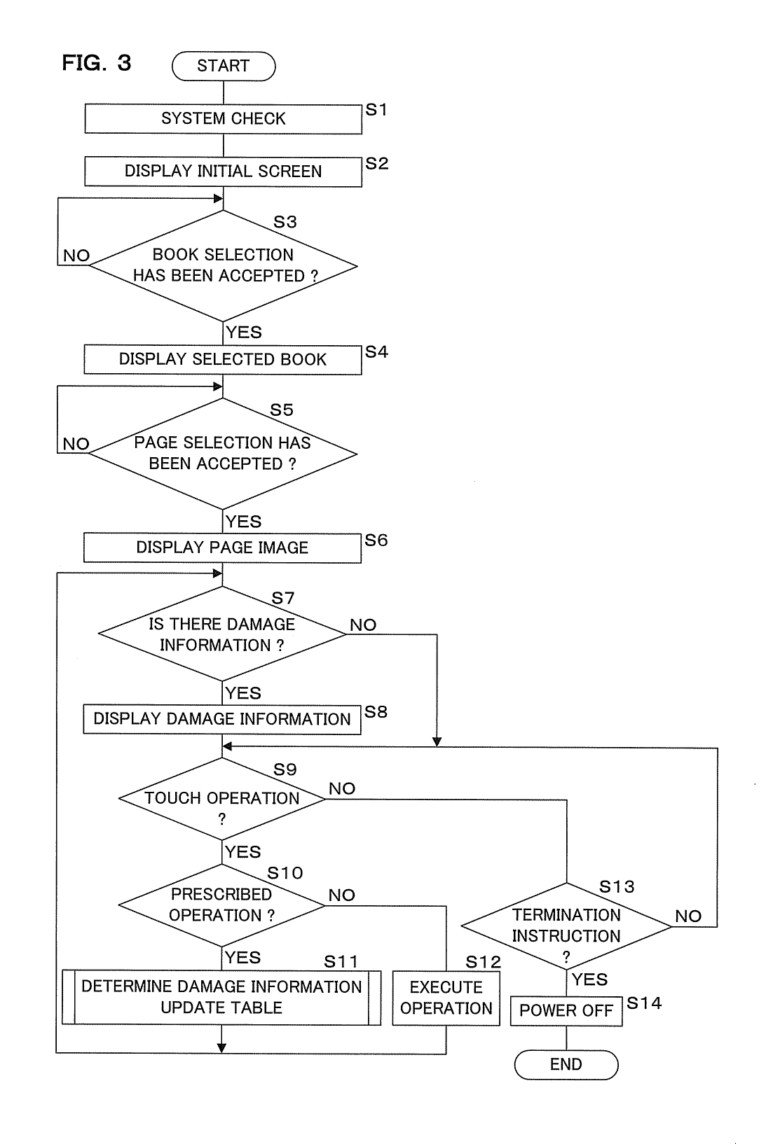

FIG. 3 is a flowchart explaining the display processing conducted in the book data display unit 100 of Embodiment 1 of the invention.

When a user turns on a power switch (not shown) of the book data display unit 100, the CPU 1 performs system check (step S1), and when there is no problem in the system, a digital book selection screen is displayed as an initial screen (step S2).

The user selects a desired digital book out of a plurality of digital books displayed in the selection screen through, for example, an operation to touch the display screen of the display part 6. Through the touch operation performed by the user at this point, the CPU 1 accepts a selection of any of the digital books through the operation detection part 8.

On the basis of a signal supplied from the operation detection part 8, the CPU 1 determines whether or not the selection of a digital book has been accepted (step S3). When it is determined that the selection of a digital book has not been accepted (i.e., NO in step S3), the CPU 1 repeats this determination until the selection of a digital book is accepted.

Furthermore, when it is determined that the selection of a digital book has been accepted (i.e., YES in step S3), the CPU 1 directs the display control part 7 to display a digital book corresponding to the accepted selection. The display control part 7 displays, in response to the direction of the CPU 1, an image and a page selection screen of the selected digital book in the display part 6 on the basis of book data stored in the book data storing section 41 (step S4).

The user selects a page he/she wants through, for example, an operation to touch the page selection screen. Through this touch operation performed at this point by the user, the CPU 1 accepts a page selection through the operation detection part 8.

The CPU 1 determines, on the basis of a signal supplied from the operation detection part 8, whether or not the page selection has been accepted (step S5). When it is determined that the page selection has not been accepted (i.e., NO in step S5), the CPU 1 repeats this determination until the page selection is accepted.

When it is determined that the page selection has been accepted (i.e., YES in step S5), the CPU 1 directs the display control part 7 to display an image of a page corresponding to the accepted selection. The display control part 7 displays, in response to the direction of the CPU 1, the image of the selected page in the display part 6 on the basis of the book data stored in the book data storing section 41 (step S6).

The CPU 1 determines whether or not there is damage information corresponding to the displayed image on the basis of, for example, the information management table 43 of FIG. 2 (step S7). When it is determined that there is no damage information corresponding to the displayed image (i.e., NO in step S7), the CPU 1 proceeds the processing to step S9.

When it is determined that there is damage information corresponding to the displayed image (i.e., YES in step S7), the CPU 1 directs the display control part 7 to display an image corresponding to the damage information. The display control part 7 displays, in response to the direction of the CPU 1, the damage information in the display part 6 on the basis of damage data stored in the damage data storing section 42 by referring to the information management table 43 (step S8).

The CPU 1 determines, by monitoring the operation detection part 8, whether or not an operation to touch on the display screen of the display part 6 has been performed by the user (step S9).

When it is determined that the operation to touch on the display screen of the display part 6 has been performed by the user (i.e., YES in step S9), the CPU 1 determines whether or not the operation performed by the use is a prescribed operation (step S10). The prescribed operation, which herein means an operation resulting in forming simulated damage in the displayed content, may be set as the needs arises.

In this embodiment, for convenience of explanation, as examples of the prescribed operation, four operations are given: operations to turn and return a page at a speed higher than a prescribed speed; an operation to dog-ear; and an operation to press a binding part.

The operations to turn and return a page are touch operations accompanying movement in the lateral direction in the touch panel and having a moving speed larger than a previously set threshold value V0. At this point, the threshold value V0 is a threshold value corresponding to a moving speed at which a rumple may be caused in a real book. The operation to dog-ear is a two-point touch operation in, for example, a portion of the touch panel corresponding to an end of a page. The operation to press a binding part is an operation to touch a portion of the touch panel corresponding to a binding part.

When it is determined that the operation performed by the user is the prescribed operation (i.e., YES in step S10), the CPU 1 directs a information determination part 5 to determine damage information.

The information determination part 5 determines, in response to the direction of the CPU 1, damage information on the basis of the accepted operation, the CPU 1 updates the information management table 43 by listing the determined damage information in the information management table 43, and when the accepted operation is a specific operation, out of the prescribed operations, such as the operation to turn/return a page, the specific operation is executed (step S11). Next, the CPU 1 returns the processing to step S7.

When it is determined that the accepted operation is not a prescribed operation (i.e., NO in step S10), the CPU 1 executes the accepted operation (step S12) and returns the processing to step S7.

When it is determined that the operation to touch on the display screen has not been performed by the user (i.e., NO in step S9), the CPU 1 determines, by monitoring the power switch (not shown), whether or not a termination instruction has been accepted (step S13).

When it is determined that a termination instruction has not been accepted (i.e., NO in step S13), the CPU 1 returns the processing to step S9. On the other hand, when it is determined that a termination instruction has been accepted (i.e., YES in step S13), the CPU 1 turns off the power switch (step S14), and the processing is thus terminated.

In this manner, in the book data display unit 100 of this embodiment, on the basis of a detection result for an operation performed by a user obtained by the operation detection part 8, the information determination part 5 determines damage information corresponding to the detected operation, and the display control part 7 displays the damage information together with the content in the display part. Therefore, simulated damage formed in the content displayed by an operation performed by a user may be displayed, so as to attain an effect to make the content similar to a real book. Furthermore, since the information management table 43 is updated by listing damage information corresponding to the simulated damage caused by the operation, the simulated damage having been previously formed may be displayed together with the content when the corresponding page image is displayed again. Therefore, an operation more similar to handling of a real book may be performed without making a user who is familiar with real books feel uncomfortable.

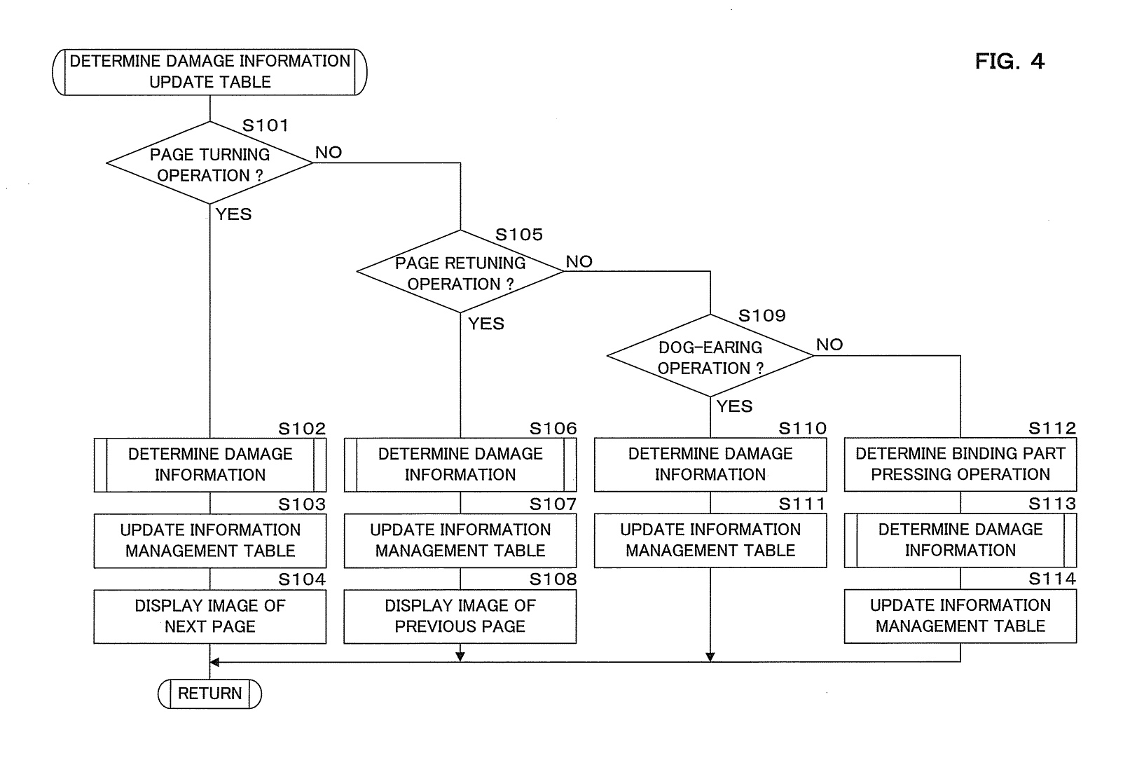

Next, a specific example of the processing conducted in step S11 of FIG. 3 will be described with reference to FIG. 4.

FIG. 4 is a flowchart illustrating a specific example of the processing conducted when a prescribed operation is accepted.

When it is determined in step S10 of FIG. 3 that the accepted operation is a prescribed operation, the CPU 1 determines whether or not the operation is the page turning operation as illustrated in FIG. 4 (step S101).

When it is determined to be a page turning operation (i.e., YES in step S101), the CPU 1 directs the information determination part 5 to determine damage information. The information determination part 5 determines, in response to the direction of the CPU 1, damage information corresponding to the page turning operation (step S102).

The CPU 1 updates the information management table 43 by listing the determined damage information in the information management table 43 (step S103) and directs the display control part 7 to display a next page.

In response to the direction of the CPU 1, the display control part 7 displays an image of the next page in the display part 6 (step S104). Subsequently, the CPU 1 returns the processing.

Alternatively, when it is determined that the operation is not a page turning operation (i.e., NO in step S101), the CPU 1 determines whether or not the operation is a page returning operation (step S105). When it is determined to be a page retuning operation (i.e., YES in step S105), the CPU 1 directs the information determination part 5 to determine damage information. In response to the direction of the CPU 1, the information determination part 5 determines damage information corresponding to the page returning operation (step S106).

The CPU 1 updates the information management table 43 by listing the determined damage information in the information management table 43 (step S107) and directs the display control part 7 to display a previous page.

In response to the direction of the CPU 1, the display control part 7 display an image of the previous page in the display part 6 (step S108). The CPU 1 returns the processing.

When it is determined that the operation is not a page returning operation (i.e., NO in step S105), the CPU 1 determines whether or not the operation is a dog-earing operation (step S109). When it is determined to be a dog-earing operation (i.e., YES in step S109), the CPU 1 directs the information determination part 5 to determine damage information. In response to the direction of the CPU 1, the information determination part 5 determines damage information corresponding to the dog-earing operation (step S110).

The CPU 1 updates the information management table 43 by listing the determined damage information in the information management table 43 (step S111) and returns the processing.

When it is determined that the operation is not a dog-earing operation (i.e., NO in step S109), the CPU 1 determines that the operation is a binding part pressing operation (step S112), and directs the information determination part 5 to determine damage information. In response to the direction of the CPU 1, the information determination part 5 determines damage information corresponding to the binding part pressing operation (step S113).

The CPU 1 updates the information management table 43 by listing the determined damage information in the information management table 43 (step S114) and returns the processing.

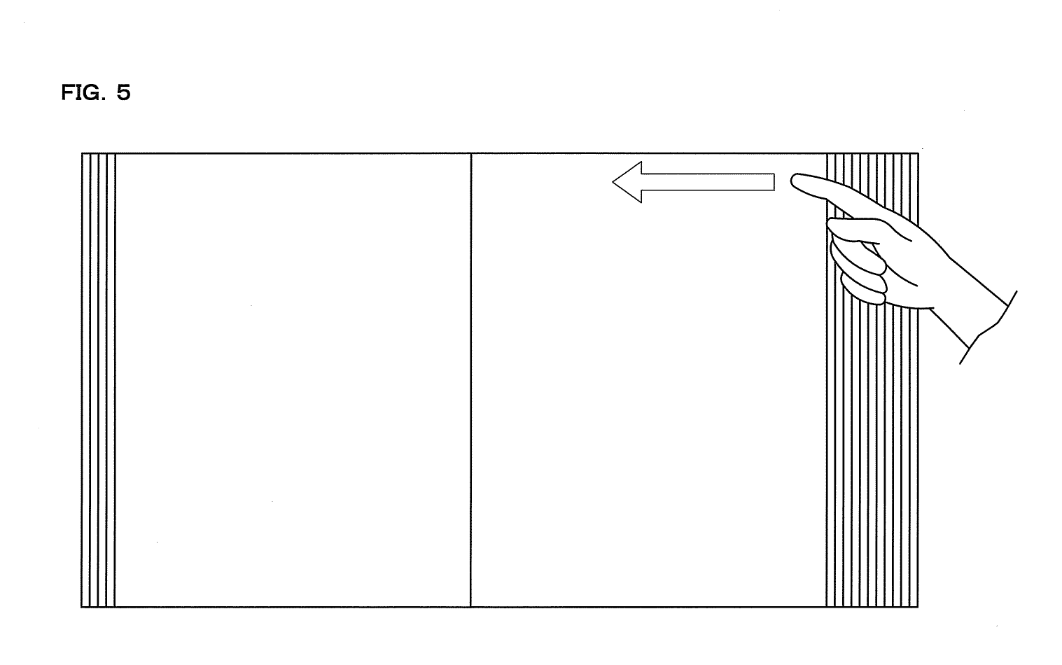

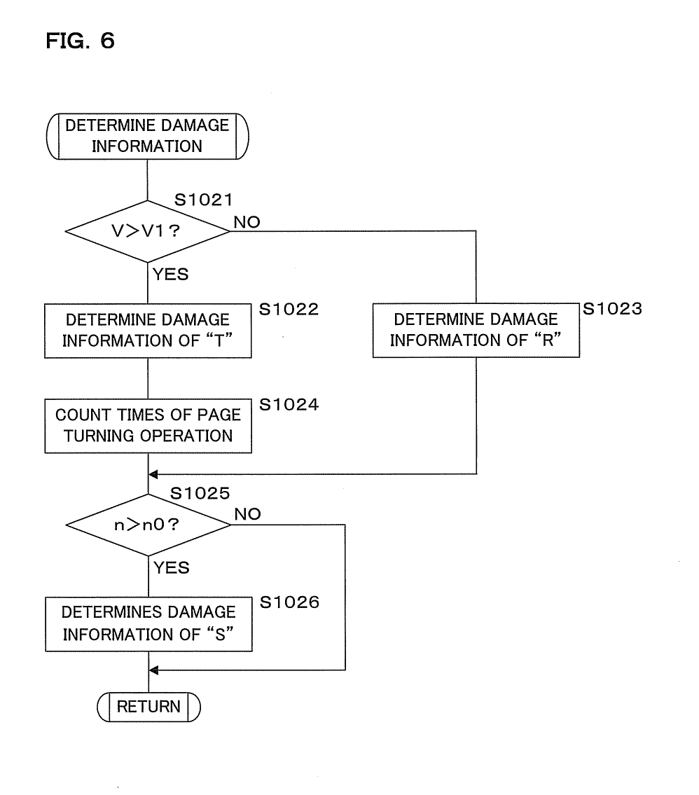

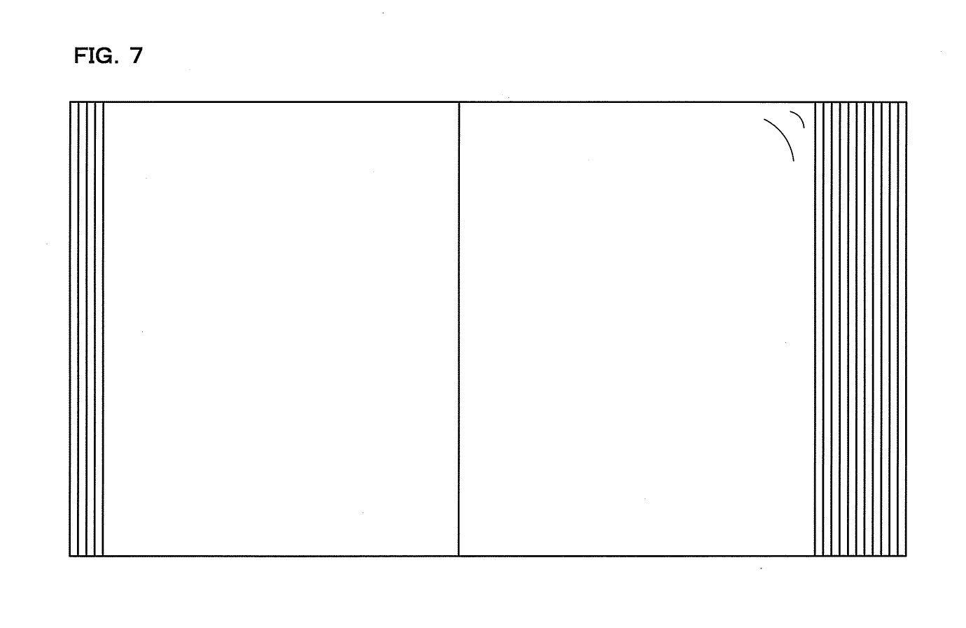

Next, an example of the processing for determining the damage information conducted in step S102 and step S103 of FIG. 4 will be described by exemplifying the page turning operation with reference to FIGS. 5 to 7. FIG. 5 is a schematic diagram illustrating the page turning operation performed by a user, FIG. 6 is a flowchart illustrating an example of the processing for determining the damage information derived from the page turning operation, and FIG. 7 is a schematic diagram simulatively displaying, in the display screen, damage caused by a page turning operation.

When a user conducts a page turning operation by touching the display screen with his/her fingertip and sliding it in the leftward direction as illustrated in FIG. 5, the operation detection part 8 accepts the page turning operation and detects a moving speed V of the fingertip of the user.

When it is determined in step S101 of FIG. 4 that the accepted operation is a page turning operation, the CPU 1 determines whether or not the moving speed V detected by the operation detection part 8 is larger than a prescribed speed V1 as illustrated in FIG. 6 (step S1021). At this point, the prescribed speed V1 is a speed at which a tear is caused in a real book and hence is set to be larger than the threshold value V0.

When it is determined that the moving speed V is larger than the prescribed speed V1 (i.e., YES in step S1021), the CPU 1 determines “T” corresponding to a tear formed in the page as the damage information (step S1022).

When it is determined that the moving speed V is not larger than the prescribed speed V1 (i.e., NO in step S1021), the CPU 1 determines “R” corresponding to a rumple formed in the page as the damage information (step S1023).

The CPU 1 counts the number n of times the page turning operation is performed (step S1024), determines whether or not the number n is larger than a previously set threshold value n0 (step S1025), and returns the processing when it is determined that the number n is not larger than the previously set threshold value n0 (i.e., NO in step S1025). At this point, the threshold value n0 is a threshold value of the number of times of the page turning operation by which a soil is caused in a real book.

When it is determined that the number n is larger than the previously set threshold value n0 (i.e., YES in step S1025), the CPU 1 determines “S” corresponding a soil formed in a corner of the page image as the damage information (step S1026) and returns the processing.

In this manner, in displaying a given page image, in the case where a page turning operation is conducted at a moving speed not as high as the prescribed speed V1, the information management table lists the damage information that a rumple is to be formed in the image page, and therefore if the page image is displayed again, a rumple is displayed in a portion of the display screen corresponding to the touch operation, for example, as illustrated in FIG. 7.

Accordingly, in the book data display unit 100 of this embodiment, the damage information may be determined on the basis of the moving speed of a touch operation conducted on the display screen and the number of times the page turning operation is conducted. However, the above operation does not limit the invention. The damage information may be determined on the basis of either the moving speed of the touch operation or the number of times of the page turning operation or on the basis of another condition.

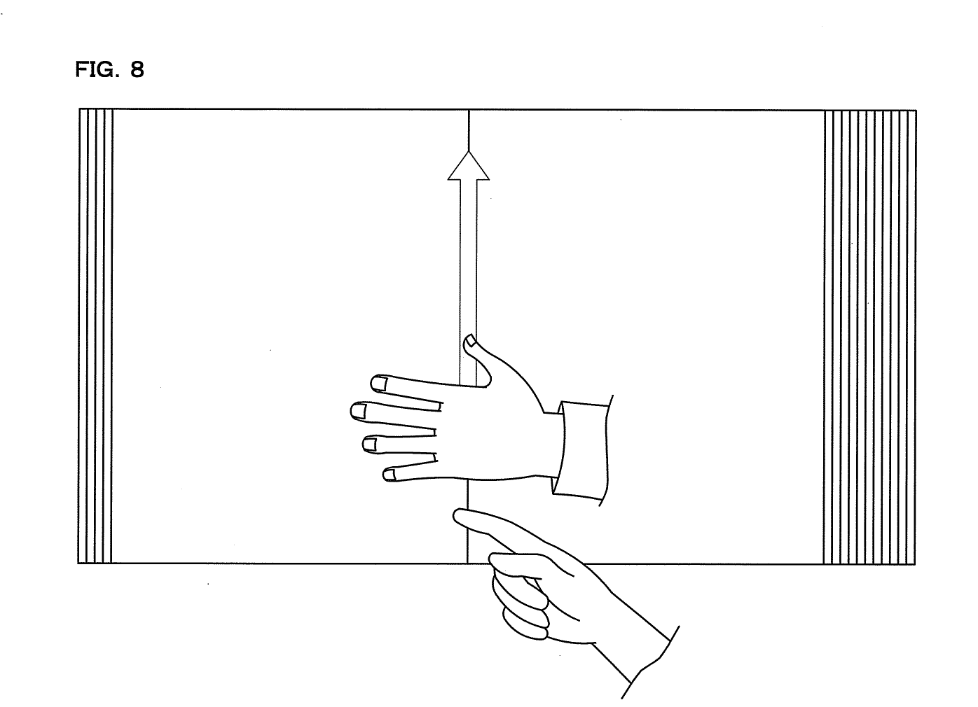

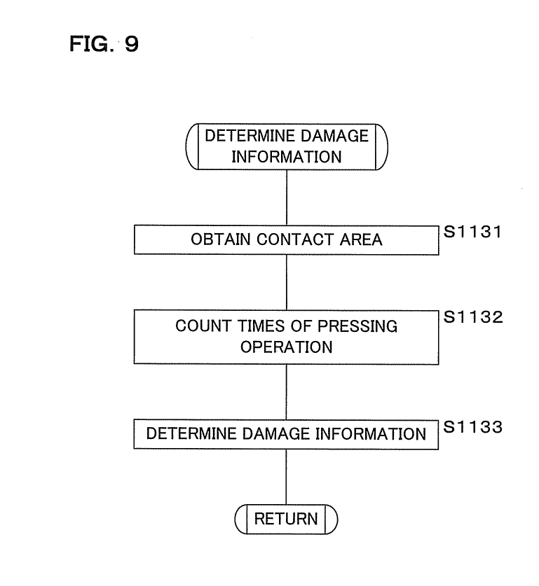

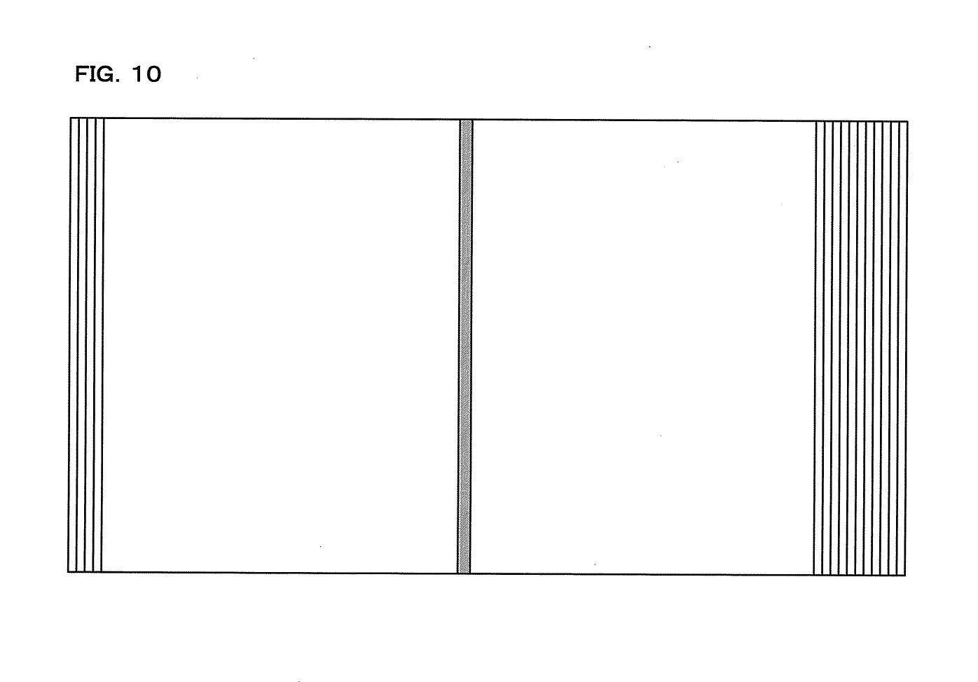

Subsequently, an example of the processing for determining the damage information conducted in step S113 of FIG. 4 will be described by exemplifying the binding part pressing operation with reference to FIGS. 8 to 10. FIG. 8 is a schematic diagram illustrating the binding part pressing operation performed by a user, and FIG. 9 is a flowchart illustrating an example of the processing for determining the damage information derived from the binding part pressing operation. FIG. 10 is a schematic diagram simulatively displaying, in the display screen, damage caused by the binding part pressing operation.

When a user performs the binding part pressing operation by touching a binding part of the display screen with his/her fingertip or palm and sliding it up and down as illustrated in FIG. 8, the operation detection part 8 accepts the binding part pressing operation and detects a contact area of the fingertip or palm of the user on the display screen.

When it is determined in step S112 of FIG. 4 that the operation is a binding part pressing operation, as illustrated in FIG. 9, the CPU 1 obtains the detected contact area of the touch operation (step S1131), counts the number of times the binding part pressing operation is performed on each page (step S1132), determines damage information corresponding to an easily opened page on the basis of the contact area and the number of times the operation is performed (step S1133) and returns the processing.

In this manner, in the case where the binding part pressing operation is performed in displaying a digital book with facing pages, the information management table lists the damage information that the easily opened page corresponding to the extent of the pressing is to be caused, and therefore, the binding part is displayed to have a larger width than in other pages, for example, as illustrated in FIG. 10.

Accordingly, in the book data display unit 100 of this embodiment, the damage information may be determined on the basis of the contact area of the touch operation in the display screen and the number of times the binding part pressing operation is performed. However, the above operation does not limit the invention. The damage information may be determined on the basis of either the contact area of the touch operation or the number of times the binding part pressing operation is performed, or on the basis of another condition.

Although the four operations of the page turning operation and the page returning operation at the moving speed of the touch operation larger than the threshold value V0, the dog-earing operation and the binding part pressing operation are exemplarily described as the prescribed operation in this embodiment, the prescribed operation is not limited to them but may be operations with other details or some of these operations in this embodiment.

For example, a display operation may be regarded as the prescribed operation, and the time of displaying every page may be counted, and damage information that the color of a page is to be changed when the total display time of the page exceeds a prescribed value may be listed in the information management table. Furthermore, an operation to provide information that a bookmark is to be placed between pages or a writing operation to add characters to a page image may be used in this embodiment.

Although the “rumple”, “tear”, “corner soil”, “dog-ear” and “width increase of a binding part” are exemplified as the display form of the damage information in this embodiment, the display form is not limited to them but another form may be displayed.

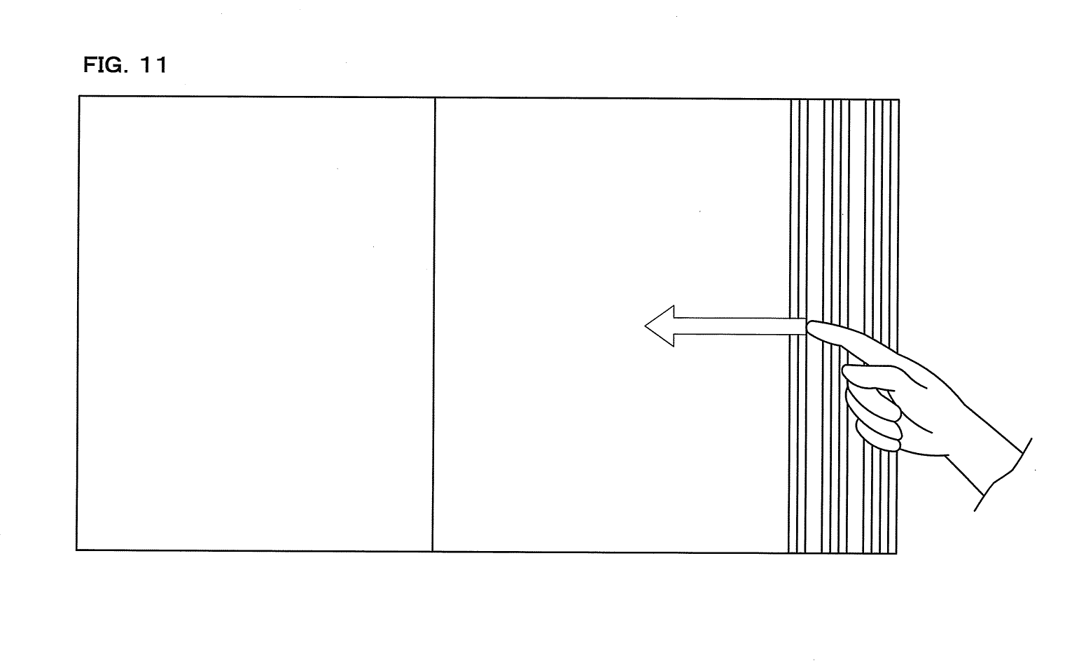

FIG. 11 is a schematic diagram illustrating an example of the display form of damage information. As illustrated in FIG. 11, in the so-called “fore-edge” part where ends of a plurality of pages are aligned on both sides of a digital book displayed in a double-page mode, a distance between pages associated with the “W” in the information management table 43 may be displayed to be large or distances between the leaf of a page associated with another damage information and adjacent leaves may be displayed to be large. Furthermore, pages associated with the damage information may be successively displayed by flicking the fore-edge part.

Since a distance between the leaf of a page associated with each damage information and an adjacent leaves is thus large in the fore-edge part, there is a high probability that a portion corresponding to a large distance is selected when the fore-edge part is touched with a finger, and hence, a page associated with damage information is displayed prior to other pages. Thus, an effect to make the content more similar to a real book may be attained.

Although the touch operation is exemplarily described as the operation performed on the display screen in this embodiment, the operation is not limited to the touch operation but may be a conventional clicking operation or a noncontact operation in this embodiment. For example, in a display unit equipped with a noncontact gesture input controller, an operation to turn a page in a screen may be recognized by detecting the movement (the direction) of a hand turning a page.

### Embodiment 2

In Embodiment 2, the display unit of Embodiment 1 further includes means for detecting its own movement and attitude. Incidentally, the description of Embodiment 1 is to be referred to in the following description with respect to configurations similar to those of Embodiment 1 and hence the description is herein omitted. It is noted that like reference numerals are used to refer to like elements used in Embodiment 1.

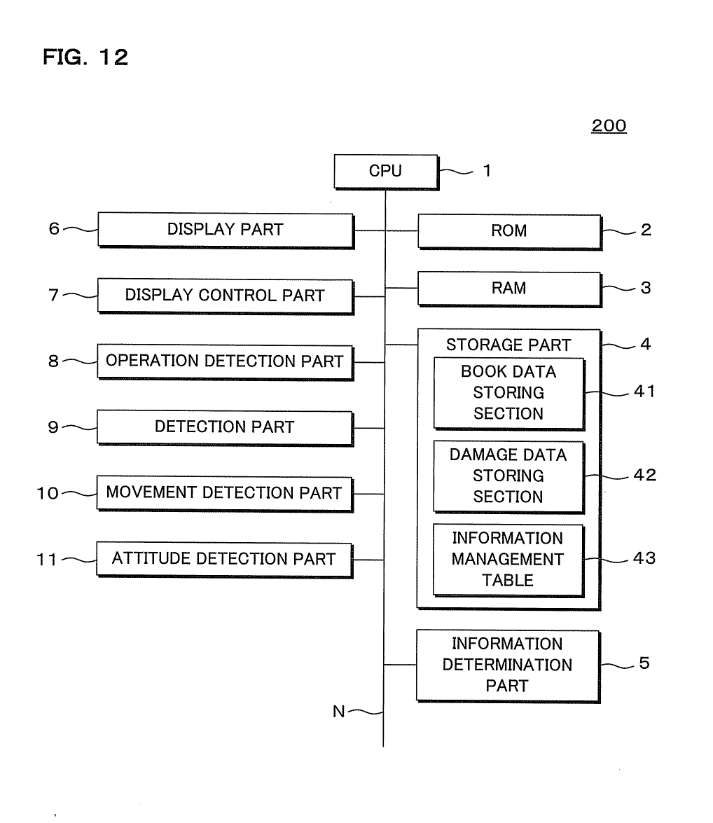

FIG. 12 is a functional block diagram illustrating the main part configuration of a book data display unit 200 according to Embodiment 2 of the invention. As illustrated in FIG. 12, the book data display unit 200 additionally includes a detection part 9, a movement detection part 10 and an attitude detection part 11.

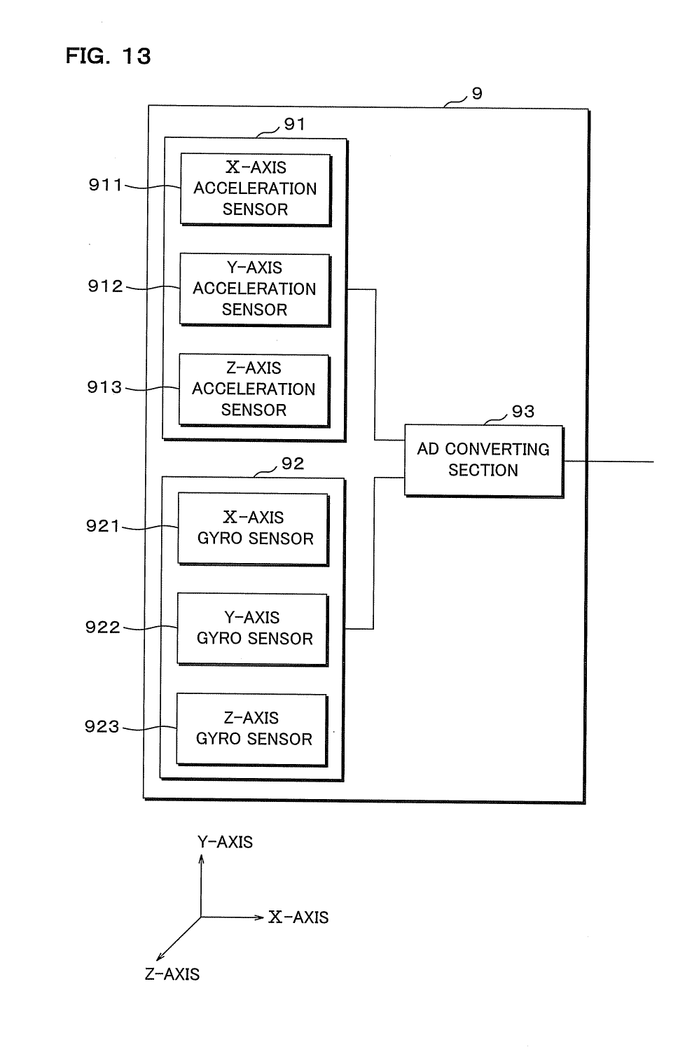

FIG. 13 is a functional block diagram illustrating the main part configuration of the detection part 9 of the book data display unit 200 of Embodiment 2 of the invention. The detection part 9 includes an acceleration sensor 91 for detecting gravity and acceleration in a plurality of directions and a gyro sensor 92 for detecting angular velocity in a plurality of directions.

The acceleration sensor 91 includes, as illustrated in FIG. 13, an X-axis acceleration sensor 911, a Y-axis acceleration sensor 912 and a Z-axis acceleration sensor 913 for detecting the gravity and the acceleration respectively in the X-axis direction, the Y-axis direction and the Z-axis direction crossing one another at right angles.

Furthermore, the gyro sensor 92 includes an X-axis gyro sensor 921, a Y-axis gyro sensor 922 and a Z-axis gyro sensor 923 for detecting angular velocity with the X-axis, the Y-axis and the Z-axis crossing one another at right angles respectively regarded as rotation axes.

Accordingly, the linear movement of the book data display unit 200 in the upward, downward, rightward, leftward, forward and backward directions may be detected by the acceleration sensor 91, and the rotational movement of the book data display unit 200 may be detected by the gyro sensor 92.

The acceleration sensor 91 and the gyro sensor 92 are both connected to an AD converting section 93, and output signals output from the gyro sensor 92 and the acceleration sensor 91 in accordance with their detection results are sent to the AD converting section 93 to be converted from analog signals into digital signals, and the digital signals are supplied to a CPU 1.

The movement detection part 10 detects the movement of the book data display unit 200 in the various directions on the basis of the detection results obtained by the acceleration sensor 91 and/or the gyro sensor 92. For example, the movement detection part 10 may determine, on the basis of the detection results obtained by the acceleration sensor 91 and/or the gyro sensor 92, a given movement as a movement of the book data display unit 200 “shaken” in the upward and downward directions.

The attitude detection part 11 detects, on the basis of the detection results obtained by the acceleration sensor 91 and/or the gyro sensor 92, which face of the book data display unit 200 faces which direction, namely, the attitude of the book data display unit 200. For example, the attitude detection part 11 may determine, on the basis of the detection results obtained by the acceleration sensor 91 and/or the gyro sensor 92, whether or not a display part 6 of the book data display unit 200 faces downward.

The detection results obtained by the movement detection part 10 and the attitude detection part 11 described above are supplied to the CPU 1. Accordingly, the CPU 1 may determine, on the basis of the detection results obtained by the movement detection part 10 and the attitude detection part 11, whether or not the book data display unit 200 itself has been shaken in the upward/downward direction or whether and not the display part 6 faces downward.

As a result, the book data display unit 200 of this embodiment detects an impact given thereto by using the acceleration sensor 92, and when an impact is detected, damage on a corner of a book may be displayed by a display control part 7 on the basis of the detected impact.

Furthermore, in the case where the CPU 1 determines that the display part 6 faces downward and that the book data display unit 200 itself has been shaken in the upward and downward directions, the CPU 1 clears damage information of a digital book currently displayed. Thus, the digital book may be easily initialized to a fresh state.

### Embodiment 3

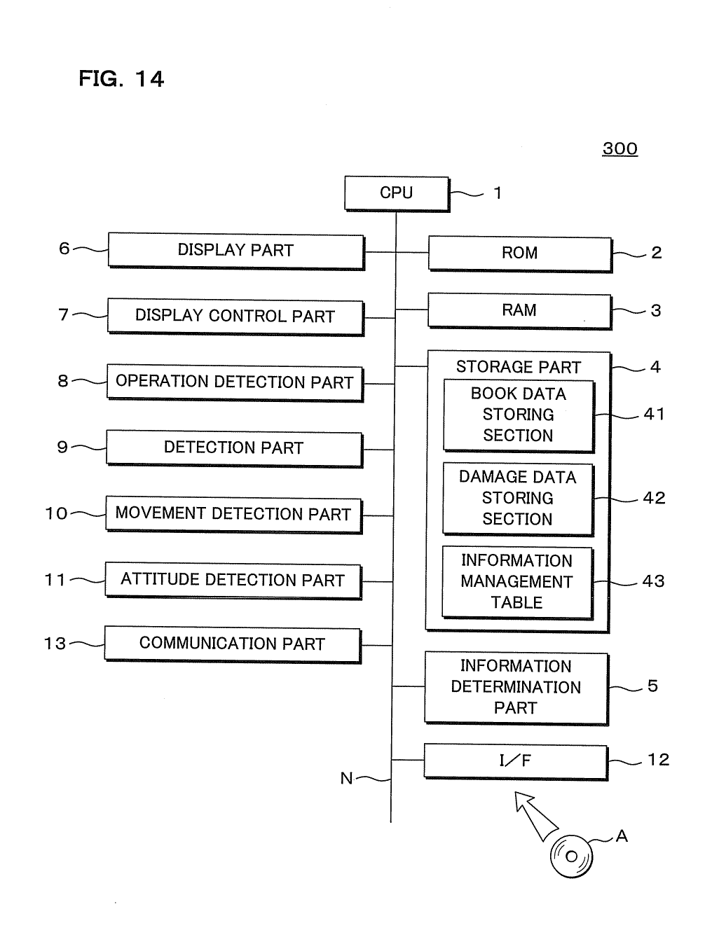

FIG. 14 is a functional block diagram illustrating the main part configuration of a book data display unit 300 according to Embodiment 3 of the invention. Like reference numerals are used to refer to like elements used in Embodiments 1 and 2 so as to omit the detailed description.

The book data display unit 300 of Embodiment 3 is constructed so that a computer program used for its operation may be provided by a portable recording medium A such as a CD-ROM through an I/F 12. Furthermore, the book data display unit 300 of Embodiment 3 is constructed so that the computer program may also be downloaded from an external device not shown through a communication part 13. These points will now be described.

The book data display unit 300 of Embodiment 3 externally (or internally) includes a recording medium reader (not shown), and the portable recording medium A, which stores a program or the like for determining whether or not an operation detected by an operation detection part 8 is a prescribed operation and for determining damage information corresponding to simulated damage to be formed by the operation when the detected operation is determined as the prescribed operation, is loaded to the recording medium reader so that, for example, a CPU 1 may install the program in a ROM 2. This program is loaded onto a RAM 3 to be executed. In this manner, the book data display unit 300 is able to function as the book data display unit of the present invention.

The recording medium may be what is called a program medium and may be any of media fixedly holding program codes including a tape-type medium such as a magnetic tape or a cassette tape, a disk-type medium such as a magnetic disk like a flexible disk or a hard disk or an optical disk like a CD-ROM, an MO, an MD or a DVD, a card-type medium such as an IC card (including a memory card) or an optical card, or a semiconductor memory such as a mask ROM, an EPROM, an EEPROM or a flash ROM.

Alternatively, the recording medium may be a medium that holds program codes in a fluid manner so as to download program codes from a network through the communication part 13. Incidentally, in the case where a program is to be thus downloaded from a communication network, a program for executing the download may be previously stored in the main part of the unit or may be installed from another recording medium. It is noted that the present invention may be practiced also when the program codes are computer data signals implemented through electric transfer and buried in carrier waves.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A display unit, comprising:
a display part displaying content in a display screen;
a detection part detecting an operation performed on the display screen of the display part; and
an information display part displaying, on the basis of a detection result obtained by the detection part, damage information corresponding to simulated damage formed in the content due to the operation.

2. The display unit according to claim 1, further comprising:
a determination part determining the damage information on the basis of details of the operation and/or the number of times the operation is performed.

3. The display unit according to claim 2,
wherein the content is an image group including images of a plurality of pages,
the display unit further comprises a storage part storing the damage information in correspondence with a page of the content where the simulated damage corresponding to the damage information has been formed, and
when the page is displayed in the display part, the information display part displays the damage information corresponding to the page.

4. The display unit according to claim 1,
wherein the content is an image group including images of a plurality of pages,
the display unit further comprises a storage part storing the damage information in correspondence with a page of the content where the simulated damage corresponding to the damage information has been formed, and
when the page is displayed in the display part, the information display part displays the damage information corresponding to the page.

5. A display method employed in a display unit for displaying content in a display screen, comprising the steps of:
detecting an operation performed on the display screen of the display unit; and
displaying, on the basis of a detected result, damage information corresponding to simulated damage formed in the content due to the operation.

6. A non-transitory recording medium storing a computer program employed in a computer included in a display unit equipped with a display part displaying content in a display screen and a detection part detecting an operation performed on the display screen of the display part, the computer program comprising the steps of:
allowing the computer to determine whether or not the operation detected by the detection part is a prescribed operation; and
allowing the computer to determine damage information corresponding to simulated damage formed in the content due to the operation when the detected operation is determined as the prescribed operation.
